(19) United States
(12) Patent Application Publication
(10) Pub. No.: US 2026/0151294 A1
(43) Pub. Date: Jun. 4, 2026

(54) Backrest Assembly and Backrest Cushion

(71) Applicant: SHENZHEN TOHACHI INDUSTRIAL CO., LTD., Shenzhen (CN)

(72) Inventor: Yong LI, Shenzhen (CN)

(21) Appl. No.: 19/037,696

(22) Filed: Jan. 27, 2025

(30) Foreign Application Priority Data
Nov. 29, 2024 (CN) 2024117422131

(51) Int. Cl. A61H 23/02

(52) U.S. Cl. CPC A61H 23/02; A61H 2201/0149

(57) ABSTRACT

The present application provides a backrest assembly and a backrest cushion, the backrest cushion body includes a first main body portion and a second main body portion, the second main body portion is connected to the first main body portion, a leaning space is formed between the second main body portion and the first main body portion for the user to lean against, the first massage module is located in the leaning space, the first massage module includes a first support seat and a first massage member, the first support seat is connected to the first main body portion, the first support seat is provided with a first massage region, and the first massage member is arranged corresponding to the first massage region to massage the user in the leaning space, so as to facilitate the first massage member to massage the user.

### CROSS-REFERENCE TO RELATED APPLICATIONS

The present application claims priority to Chinese Patent Application No. 202411742213.1, filed on Nov. 29, 2024, the entire disclosure of which is incorporated herein by reference.

### TECHNICAL FIELD

The present application relates to the technical field of backrest cushions, and particularly to a backrest assembly and a backrest cushion.

### BACKGROUND

With the development of science and technology, back cushions are used in people's lives, and back cushions are used to adjust the contact point between the human body and the seat to obtain a more comfortable angle to reduce the fatigue of the user.

In the related art, the existing back cushion includes a back cushion body, the back cushion body is used for the user to lean against, and the back cushion body is provided with at least one contact portion, and the contact portion is used for the user to contact, but the back cushion body cannot massage, and only has leaning function, which results in the function of existing back cushion being poorer.

### SUMMARY

The purpose of the present application is to provide a backrest assembly and a backrest cushion, the backrest cushion body includes a first main body portion and a second main body portion, the second main body portion is connected to the first main body portion, a leaning space is formed between the second main body portion and the first main body portion for the user to lean against, the first massage module is located in the leaning space, the first massage module includes a first support seat and a first massage member, the first support seat is connected to the first main body portion, the first support seat is provided with a first massage region, and the first massage member is arranged corresponding to the first massage region to massage the user in the leaning space, so as to facilitate the first massage member to massage the user, and facilitate the backrest cushion body to integrate the leaning function and the massage function through the first massage module, such that the massage effect of the backrest cushion body is achieved, and the backrest cushion body is avoided to have only the leaning function, enriching the functionality of the backrest assembly.

In order to realize the above purpose, the present application provides the following technical solution:
A backrest assembly, applied to a backrest cushion, comprising:
   a backrest cushion body, comprising a first main body portion and a second main body portion, wherein the second main body portion is connected to the first main body portion, a leaning space is formed between the second main body portion and the first main body portion, and the leaning space is configured for a user to lean against; and
   a first massage module, being in the leaning space, where the first massage module comprises a first support seat and a first massage member, the first support seat is connected to the first main body portion, the first support seat is provided with a first massage region, and the first massage member is arranged corresponding to the first massage region and is configured to massage the user in the leaning space.

A backrest cushion includes the backrest assembly.

The beneficial effects of the present application compared to the related art are:
The present application is to provide a backrest assembly and a backrest cushion, the backrest cushion body includes a first main body portion and a second main body portion, the second main body portion is connected to the first main body portion, a leaning space is formed between the second main body portion and the first main body portion for the user to lean against, the first massage module is located in the leaning space, the first massage module includes a first support seat and a first massage member, the first support seat is connected to the first main body portion, the first support seat is provided with a first massage region, and the first massage member is arranged corresponding to the first massage region to massage the user in the leaning space, so as to facilitate the first massage member to massage the user, and facilitate the backrest cushion body to integrate the leaning function and the massage function through the first massage module, such that the massage effect of the backrest cushion body is achieved, and the backrest cushion body is avoided to have only the leaning function, enriching the functionality of the backrest assembly.

### BRIEF DESCRIPTION OF THE DRAWINGS

In order to more clearly illustrate the technical solutions in the embodiments of the present application, the accompanying drawings to be used in the description of the embodiments will be briefly described below. Obviously, the accompanying drawings in the following description are only some of the embodiments of the present application, and other accompanying drawings may be obtained from these drawings without creative labor for those skilled in the art.

For a more complete understanding of the present application and its beneficial effects, the following description will be given in conjunction with the accompanying drawings. The same accompanying drawing symbols in the following description indicate the same portions.

FIG. 1 is a schematic view of a backrest assembly according to the present application.

FIG. 2 is a schematic diagram of a back cushion body of the backrest assembly according to the present application.

FIG. 3 is a schematic diagram of a first massage module of the backrest assembly according to the present application.

FIG. 4 is a cross-sectional view of the first massage module of the backrest assembly being a red light emitting member according to the present application.

FIG. 5 is a cross-sectional view of the first massage module of the backrest assembly being a vibration massage member according to the present application.

FIG. 6 is a cross-sectional view of the first massage module of the backrest assembly being a heat generation massage member according to the present application.

FIG. 7 is a schematic view of a second massage module of the backrest assembly according to the present application.

FIG. 8 is a cross-sectional view of the second massage module of the backrest assembly being a red light emitting member according to the present application.

FIG. 9 is a cross-sectional view of the second massage module of the backrest assembly being a vibration massage member according to the present application.

FIG. 10 is a cross-sectional view of the second massage module of the backrest assembly being a heat generation massage member according to the present application.

### DETAILED DESCRIPTION OF THE EMBODIMENTS

The technical solutions in the embodiments of the present application will be clearly and completely described below in conjunction with the accompanying drawings in the embodiments of the present application. Obviously, the described embodiments are only a portion of the embodiments of the present application, and not all of the embodiments. Based on the embodiments in present application, all other embodiments obtained by those skilled in the art without making creative labor fall within the scope of the present application.

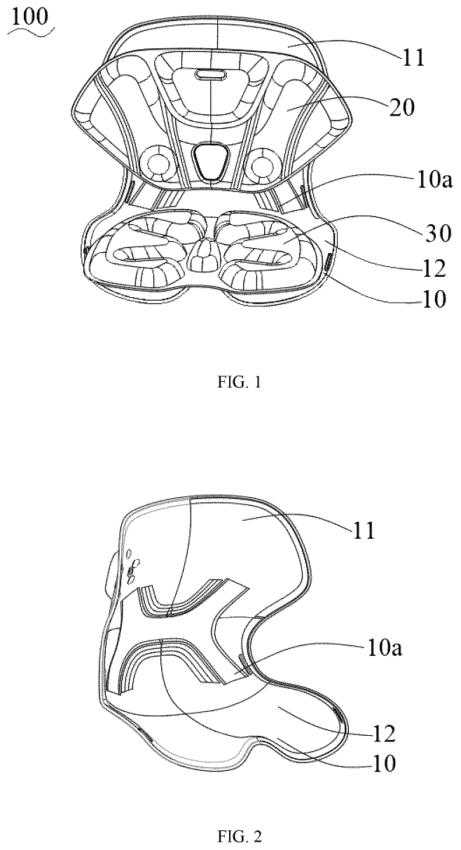

Referring to FIGS. 1 to 2, embodiments of the present application provide a backrest assembly 100, the backrest assembly 100 is applied to a backrest cushion, the backrest assembly 100 is used for leaning and massaging a user.

Referring to FIGS. 1 to 2, in the embodiment of the present application, the backrest assembly 100 includes a backrest cushion body 10 and a first massage module 20; the first massage module 20 is provided on an inside of the backrest cushion body 10, the backrest cushion body 10 includes a first main body portion 11 and a second main body portion 12, the second main body portion 12 is connected to the first main body portion 11, and a leaning space 10a is formed between the second main body portion 12 and the first main body portion 11 for the user to lean against. The first massage module 20 is in the leaning space 10a. The first massage module 20 includes a first support seat 21 and a first massage member 22. The first support seat 21 is connected to the first main body portion 11, the first support seat 21 is provided with a first massage region 211, the first massage member 22 is arranged corresponding to the first massage region 211 to massage the user in the leaning space 10a, so as to facilitate the first massage member 22 to massage the user, and facilitate the backrest cushion body 10 to integrate the leaning function and the massage function through the first massage module 20, the massage effect of the backrest cushion body 10 is achieved, and the backrest cushion body 10 is avoided to have only the leaning function, enriching the functionality of the backrest assembly 100.

Referring to FIGS. 1 to 2, in the embodiment of the present application, the backrest cushion body 10 serves as a support component of the backrest assembly 100, and the backrest cushion body 10 is configured to support the first massage module 20 and the second massage module 30.

Referring to FIGS. 1 to 2, at this time, the backrest cushion body 10 includes a first main body portion 11 and a second main body portion 12, the second main body portion 12 is connected to the first main body portion 11, so as to facilitate fixing of the second main body portion 12 to the first main body portion 11, and a leaning space 10a is formed between the second main body portion 12 and the first main body portion 11 for leaning by the user, so as to facilitate the user to enter into the leaning space 10a, thereby facilitating the inside walls of the leaning space 10a for the user to lean against in different positions, so as to obtain a more comfortable sitting posture to reduce the fatigue of the user.

Referring to FIGS. 1 to 3, in an embodiment of the present application, the first massage module 20 is located in the leaning space 10a; the first massage module 20 includes a first support seat 21 and a first massage member 22. The first support seat 21 is connected to the first main body portion 11, so as to facilitate fixing of the first support seat 21 to the first main body portion 11, and the first support seat 21 is provided with a first massage region 211, and the first massage member 22 is arranged corresponding to the first massage region 211 to massage the user in the leaning space 10a, so as to facilitate the first massage member 22 to massage the user, and facilitate the backrest cushion body 10 to integrate the leaning function and the massage function through the first massage module 20, such that the massage effect of the backrest cushion body 10 is achieved, and the backrest cushion body 10 is avoided to have only the leaning function, enriching the functionality of the backrest assembly 100.

Referring to FIGS. 1 to 3, the first main body portion 11 is located above the second main body portion 12 and is configured to support the back of the user; the first main body portion 11 is extended in a circular arc direction, so as to facilitate the adaptation of the contour of the first main body portion 11 with the back of the user to support the back of the user at different positions, such that the first main body portion 11 can massage different positions of the back of the user through the first massage member 22, for the user leaning against the first main body portion 11 and the first main body portion 11 massaging the back of the user.

Referring to FIGS. 1 to 6, the first massage member 22 is at least one of a red light emitting member, a vibration massage member, and a heat generation massage member, so as to facilitate the first massage member 22 to perform a red light massage or a vibration massage or a heat generation massage on the back of the user.

Referring to FIG. 4, when the first massage member 22 is a red light emitting member, the first massage member 22 is provided with a first red light member 221, the first red light member 221 outputs red light, and the first red light member 221 is configured to irradiate the red light to the back of the user leaning against the first main body portion 11, so as to facilitate the red light therapeutic massage of the first red light member 221 to the back of the user, thereby facilitating that the first main body portion 11 integrates the leaning function and the red light therapeutic massage function.

Referring to FIG. 4, the first massaging member 22 is provided with a first mounting section 222 and a first lens section 223. The first mounting section 222 is provided on the first support seat 21, so as to facilitate the first mounting section 222 to be fixed to the first support seat 21 and to support the first red light member 221, such that the first red light member 221 can be fixed to the first support seat 21 through the first mounting section 222, and the position accuracy of the first red light member 221 is ensured. The first lens portion 223 is connected to the first mounting portion 222, so as to facilitate that the first lens portion 223 is fixed to the first mounting portion 222, and the first lens portion 223 is arranged corresponding to the light emitting surface of the first red light member 221, so as to facilitate that red light outputted from the light emitting surface of the first red light member 221 is conducted to the back of the user through the first lens portion 223, thereby facilitating that the first lens portion 223 converges the red light output from the light emitting surface of the first red light member 221 on the back of the user.

Referring to FIG. 4, a first sealing space is formed between the first lens portion 223 and the first mounting portion 222, and the first red light member 221 is in the first sealing space, so as to facilitate that the first lens portion 223 and the first mounting portion 222 wrap around the first red light member 221, thereby facilitating that the first red light member 221 is protected by the outer surfaces of the first lens portion 223 and the first mounting portion 222, and the first red light member 221 is not in contact with the external environment, so as to facilitate the first red light member 221 to be arranged separately from the external environment, to prevent the first red light member 221 from being impacted by the external environment, such that the performance of the first red light member 221 is ensured, and the life of the first red light member 221 is improved.

Referring to FIG. 4, the first massage member 22 is provided with a first circuit board 224, the first circuit board 224 is provided on a rear side of the first red light member 221 and is built into the first support seat 21, so as to facilitate fixing of the first circuit board 224 to the inside of the first support seat 21. The first circuit board 224 is in a state of electrical connection with the first red light member 221, so as to facilitate the first circuit board 224 to energize the first red light member 221, such that the first circuit board 224 can control the first red light member 221 to be in the on state or in the off state.

Referring to FIG. 5, when the first massage member 22 is a vibration massage member, the first massage member 22 is provided with a first vibration member 225 and a first elastic portion 226, the first elastic portion 226 is connected to the first support seat 21, a fixed end of the first vibration member 225 is connected to the first support seat 21, a vibration end of the first vibration member 225 contacts the first elastic portion 226 and outputs a vibration force to the first elastic portion 226. The first vibration member 225 is configured to vibrationally massage the back of the user leaning against the first elastic portion 226, realizing a vibrational massage function of the first main body portion 11, so as to facilitate the first vibration member 225 to vibrationally massage the back of the user, such that the first main body portion 11 integrates the leaning function and the vibrational massage function.

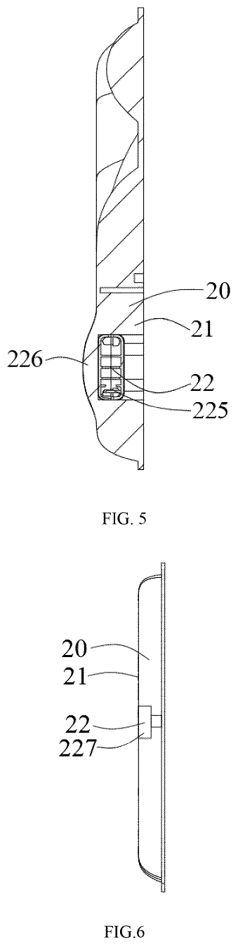

Referring to FIG. 6, when the first massage member 22 is a heat generation massage member, the first massage member 22 is provided with a first heat generation member 227, the first heat generation member 227 is connected to the first support seat 21, and the first heat generation member 227 is configured to output heat to the back of the user leaning against the first main body portion 11, thereby realizing a heating massage function of the first main body portion 11, so as to facilitate the first heat generation member 227 to perform heating massage on the back of the user, such that the first main body portion 11 integrates the leaning function and the heating massage function.

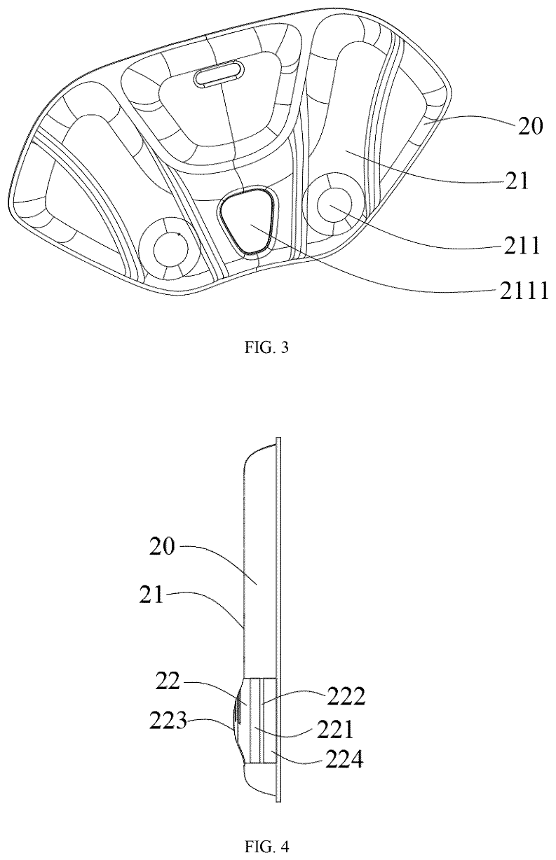

Referring to FIG. 3, a plurality of first massage regions 211 are provided and distributed at different positions of the first support seat 21. Each first massage region 211 is matched with the corresponding first massage member 22, the plurality of first massage regions 211 are provided to increase the massage areas of the first massage region 211 corresponding to the back of the user, thereby facilitating the improvement of the massage effect of the first massage region 211 corresponding to the back of the user. Optionally, the massage effect of the first massage member 22 matched by each first massage region 211 is the same, or, the massage effect of the first massage member 22 matched by each first massage region 211 varies from one to another.

Referring to FIG. 3, a first function integration region 2111 is formed among the plurality of first massage regions 211, and the first function integration region 2111 is arranged at different positions corresponding to the back of the user, so as to facilitate the first function integration region 2111 to massage different positions of the back of the user.

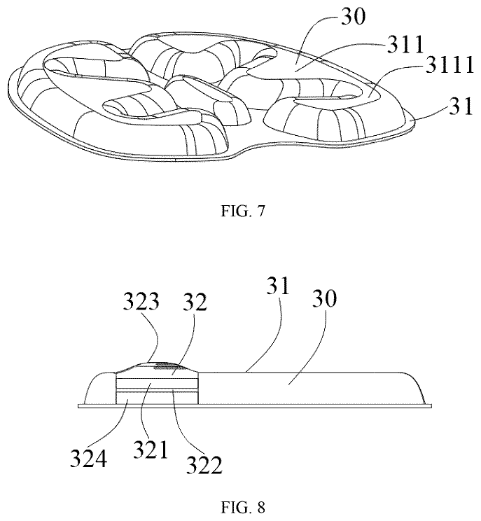

Referring to FIG. 7, in an embodiment of the present application, the backrest assembly 100 further includes a second massage module 30, the second massage module 30 is in the leaning space 10a. The second massage module 30 includes a second support seat 31 and a second massage member 32. The second support seat 31 is connected to the second main body portion 12, so as to facilitate fixing of the second support seat 31 to the second main body portion 12, the second support seat 31 is provided with a second massage region 311, the second massage member 32 is arranged corresponding to the second massage region 311 to massage the user in the leaning space 10a, so as to facilitate the second massage member 32 to massage the user, such that the second main body portion 12 integrates the leaning function and the massage function through the second massage module 30, further enriching the functionality of the backrest assembly 100.

Referring to FIGS. 1 and 7, the second main body portion 12 is located below the first main body portion 11, and the second main body portion 12 is extended in a front-to-back direction and is configured to support the buttocks of the user. The second main body portion 12 is extended in a circular arc direction, so as to allow adaptation of the contour of the second main body portion 12 with the buttocks of the user, to support the buttocks of the user at different positions, such that the second main body portion 12 can massage the different positions of the buttocks of the user through the second massage member 32, so as to realize that the buttocks of the user leans against the second main body portion 12 and the second main body portion 12 massages the buttocks of the user.

The second massage member 32 is at least one of a red light emitting member, a vibration massage member, and a heat generation massage member, so as to facilitate the second massage member 32 to perform a red light massage or a vibration massage or a heat generation massage on the buttocks of the user.

Referring to FIG. 8, when the second massage member 32 is a red light emitting member, the second massage member 32 is provided with a second red light member 321, the second red light member 321 outputs red light, and the second red light member 321 is configured to irradiate the red light to the buttocks of the user leaning against the second main body portion 12, such that the second main body portion 12 integrates a leaning function and the red light therapeutic massage function.

Referring to FIG. 8, the second massage member 32 is provided with a second mounting portion 322 and a second lens portion 323. The second mounting portion 322 is provided on the second support seat 31, so as to facilitate the second mounting portion 322 to be fixed to the second support seat 31 and to support the second red light member 321, so as to facilitate the second red light member 321 to be fixed to the second support seat 31 through the second mounting portion 322, the position accuracy of the second red light member 321 is ensured. The second lens portion 323 is connected to the second mounting portion 322, so as to facilitate that the second lens portion 323 is fixed to the second mounting portion 322, and the second lens portion 323 is provided corresponding to the light emitting surface of the second red light member 321, so as to facilitate that red light outputted from the light emitting surface of the second red light member 321 is conducted to the buttocks of the user through the second lens portion 323, thereby facilitating the second lens portion 323 to converge the red light output from the light emitting surface of the second red light member 321 on the buttocks of the user.

Referring to FIG. 8, a second sealing space is formed between the second lens portion 323 and the second mounting portion 322, and the second red light member 321 is in the second sealing space, so as to facilitate the second lens portion 323 and the second mounting portion 322 to wrap around the second red light member 321, such that the second red light member 321 is protected by the outer surfaces of the second lens portion 323 and the second mounting portion 322, and the second red light member 321 is not contact with the external environment, so as to facilitate the second red light member 321 to be arranged separately from the external environment, to prevent the second red light member 321 from being impacted by the external environment, the performance of the second red light member 321 is ensured, and the life of the second red light member 321 is improved.

Referring to FIG. 8, the second massaging member 32 is provided with a second circuit board 324, the second circuit board 324 is provided on a rear side of the second red light member 321 and is built into the second support seat 31, so as to facilitate fixing of the second circuit board 324 to the inside of the second support seat 31, and the second circuit board 324 is in a state of electrical connection with the second red light member 321, so as to facilitate the second circuit board 324 to energize the second red light member 321, thereby facilitating the second circuit board 324 to be able to control the second red light member 321 to be in the on state or in the off state.

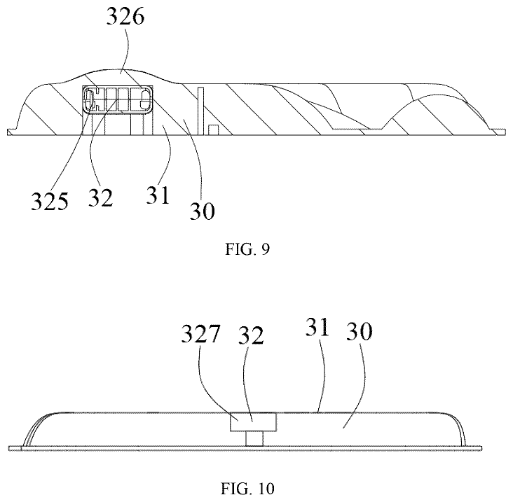

Referring to FIG. 9, when the second massage member 32 is a vibration massage member, the second massage member 32 is provided with a second vibration member 325 and a second elastic portion 326, the second elastic portion 326 is connected to the second support seat 31, a fixed end of the second vibration member 325 is connected to the second support seat 31, a vibration end of the second vibration member 325 contacts the second elastic portion 326, and outputs a vibrating force to the second elastic portion 326; the second vibration member 325 is configured to vibrationally massage the buttocks of the user leaning against the second elastic portion 326, realizing a vibrational massage function of the second main body portion 12 so as to facilitate vibrationally massaging the buttocks of the user by the second vibration member 325, thereby facilitating the second main body portion 12 to integrate the leaning function and the vibrational massage function.

Referring to FIG. 10, when the second massage member 32 is a heat generation massage member, the second massage member 32 is provided with a second heat generation member 327, the second heat generation member 327 is connected to the second support seat 31, and the second heat generation member 327 is configured to output heat to the buttocks of the user leaning against the second main body portion 12, thereby realizing a heating massage function of the second main body portion 12, so as to facilitate heating massage function of the second heat generation member 327 to the buttocks of the user, such that the second main body portion 12 integrates the leaning function and the heating massage function.

Referring to FIG. 7, a plurality of second massage regions 311 are provided and distributed at different positions of the second support seat 31; each second massage region 311 is matched with a corresponding second massage member 32, and the plurality of second massage regions 311 are provided to increase the massaging areas of the second massage region 311 corresponding to the buttocks of the user, thereby facilitating to improve the massaging effect of the second massage region 311 corresponding to the buttocks of the user. Optionally, the massage effect of the second massage member 32 matched by each second massage region 311 is the same, or the massage effect of the second massage member 32 matched by each the second massage regions 311 varies from one to another.

Referring to FIG. 7, a second function integration region 3111 is formed among the plurality of second massage regions 311, and is arranged at different positions corresponding to the buttocks of the user, so as to facilitate the second function integration region 3111 to massage different positions of the buttocks of the user.

In another embodiment, a backrest cushion includes a backrest assembly 100, the backrest assembly 100 is a portion of the backrest cushion, the backrest cushion is configured to adjust the contact point of the human body with the seat to obtain a more comfortable angle to reduce the fatigue of the user.

The beneficial effect of the present application is compared to the related art:
The present application provides a backrest assembly 100 and a backrest cushion, the backrest cushion body 10 includes a first main body portion 11 and a second main body portion 12, the second main body portion 12 is connected to the first main body portion 11, and a leaning space 10a is formed between the second main body portion 12 and the first main body portion 11 for the user to lean against. The first massage module 20 is in the leaning space 10a. The first massage module 20 includes a first support seat 21 and a first massage member 22. The first support seat 21 is connected to the first main body portion 11, the first support seat 21 is provided with a first massage region 211, the first massage member 22 is arranged corresponding to the first massage region 211 to massage the user in the leaning space 10a, so as to facilitate the first massage member 22 to massage the user, and facilitate the backrest cushion body 10 to integrate the leaning function and the massage function through the first massage module 20, such that the massage effect of the backrest cushion body 10 is achieved, and the backrest cushion body 10 is avoided to have only the leaning function, enriching the functionality of the backrest assembly 100.

In the above embodiments, the description of each embodiment has its own focus, and the portion that is not detailed in a certain embodiment can be referred to the relevant description of other embodiments.

In the description of the present application, the terms “first” and “second” are used for descriptive purposes only, and are not to be understood as indicating or implying relative importance or implicitly specifying the number of technical features indicated. As a result, a feature defined with “first” or “second” may expressly or implicitly include one or more features.

Herein adopts specific examples for elaboration of the principle and implementation of the present application, the illustration of the above examples are only used to help understand the method and the core ideas of the present application; and the those skilled in the art, based on the idea of the present application, will make some change in the specific implementation of the application and the scope of the application, in summary, the contents of this specification should not be construed as a limitation on the present application.

What is claimed is:

1. A backrest assembly, applied to a backrest cushion, comprising:
a backrest cushion body, comprising a first main body portion and a second main body portion, wherein the second main body portion is connected to the first main body portion, a leaning space is formed between the second main body portion and the first main body portion, and the leaning space is configured for a user to lean against; and
a first massage module, being in the leaning space, wherein the first massage module comprises a first support seat and a first massage member, the first support seat is connected to the first main body portion, the first support seat is provided with a first massage region, and the first massage member is arranged corresponding to the first massage region and is configured to massage the user in the leaning space;
the first main body portion and the second main body portion are in an integrated form, and a connection portion between the first main body portion and the second main body portion are curve structure;
there are elastic protrusions provided on the first main body portion and the second main body portion respectively for support the user and play a buffer function, and the first massage module and the second massage module are arranged inside the elastic protrusions;
the first main body portion is located above the second main body portion and is configured to support a back of the user, and the first main body portion is extended in a circular arc direction to support different positions of the back of the user, a width of the first main body portion and a width of the second main body portion are both wider than a width of the connection portion, and outer contour lines of the first main body portion, the connection portion, and the second main body portion are smooth transition in continuous smooth curve; and
the first massage member is at least one of a red light emitting member, a vibration massage member, and a heat generation massage member.

2-3. (canceled)

4. The backrest assembly according to claim 1, wherein a plurality of the first massage regions are provided and distributed at different positions of the first support seat; and
each first massage region is matched with a corresponding first massage member.

5. The backrest assembly according to claim 4, wherein a first function integration region is formed among the plurality of the first massage regions, and the first function integration region is arranged at different positions corresponding to the back of the user.

6. The backrest assembly according to claim 1, wherein the backrest assembly further comprises a second massage module, and the second massage module is located in the leaning space;
wherein the second massage module comprises a second support seat and a second massage member, the second support seat is connected to the second main body portion, the second support seat is provided with a second massage region, and the second massage member is arranged corresponding to the second massage region and is configured to massage the user in the leaning space.

7. The backrest assembly according to claim 6, wherein the second main body portion is located below the first main body portion, the second main body portion is extended in a front-to-back direction and is configured to support the buttocks of the user, and the second main body portion is extended in a circular arc direction to support the buttocks of the user in different positions.

8. The backrest assembly according to claim 1, wherein the second massage member is at least one of a red light emitting member, a vibration massage member, and a heat generation massage member.

9. The backrest assembly according to claim 1, wherein a plurality of the second massage regions are provided and distributed at different positions of the second support seat;
each second massage region is matched with a corresponding second massage member; and
a second function integration region is formed among the plurality of the second massage regions, and the second function integration region is arranged at different positions corresponding to the buttocks of the user.

10. The backrest assembly according to claim 1, wherein when the first massage member is a red light emitting member, the first massage member is provided with a first red light member, the first red light member outputs red light to irradiate the back of the user leaning against the first main body portion;
the first massage member is provided with a first mounting portion and a first lens portion;
the first mounting portion is provided on and fixed to the first support base to support the first red light emitting member;
the first lens portion is connected to the first mounting portion, and the first lens portion is arranged corresponding to a light emitting surface of the first red light emitting member.

11. The backrest assembly according to claim 10, wherein a first sealing space is formed between the first lens portion and the first mounting portion, the first red light member is in the first sealing space, and the first red light member is not in contact with the external environment.

12. The backrest assembly according to claim 11, wherein a first circuit board is provided at a rear side of the first red light member and built into the first support seat, and the first circuit board is electrically connected to the first red light member.

13. The backrest assembly according to claim 1, wherein when the first massage member is a vibration massage member, and the first massage member is provided with a first vibration member and a first elastic portion;
the first elastic portion is connected to the first support seat, a fixed end of the first vibration member is connected to the first support seat, and a vibration end of the first vibration member contacts the first elastic portion and outputs vibration force to the first elastic portion; and
the first vibration member is configured to vibrationally massage the back of the user leaning against the first elastic portion.

14. The backrest assembly according to claim 1, wherein when the first massage member is a heat generation massage member, the first massage member is provided with a first heat generation member, the first heat generation member is connected to the first support seat, and the first heat generation member is configured to output heat to the back of the user leaning against the first main body portion.

15. (canceled)

16. A backrest assembly, comprising:
a back cushion body, comprising a first main body portion and a second main body portion, wherein the second main body portion is connected to the first main body portion, and a leaning space is formed between the second main body portion and the first main body portion for the user to lean against;
a first massage module, located in the leaning space, wherein the first massage module comprises a first support seat and a first massage member, the first support seat is connected to the first main portion, the first support seat is provided with a first massage region, the first massage member is arranged corresponding to the first massage region to massage the user in the leaning space;
the first massage member is at least one of a red light emitting member, a vibration massage member, and a heat generation massage member; and
a massage effect of the first massage members matching each first massage region is the same, or, a massage effect of the first massage member matching each first massage region is different;
the first main body portion and the second main body portion are in an integrated form, and a connection portion between the first main body portion and the second main body portion are curve structure;
there are elastic protrusions provided on the first main body portion and the second main body portion respectively for support the user and play a buffer function, and the first massage module and the second massage module are arranged inside the elastic protrusions;
a width of the first main body portion and a width of the second main body portion are both wider than a width of the connection portion, and outer contour lines of the first main body portion, the connection portion, and the second main body portion are smooth transition in continuous smooth curve.

17. The backrest assembly according to claim 16, wherein the backrest assembly further comprises a second massage module, and the second massage module is in the leaning space;
wherein the second massage module comprises a second support seat and a second massage member, the second support seat is connected to the second main body portion, and the second support seat is provided with a second massage region, the second massage member is arranged corresponding to the second massage region to massage the user in the leaning space.

18. (canceled)

19. The backrest assembly according to claim 16, wherein the second massage member is at least one of a red light emitting member, a vibration massage member, and a heat generation massage member.

20. The backrest assembly according to claim 16, wherein the first massage member is at least one of a red light emitting member, a vibration massage member, and a heat generation massage member.
